(19) United States
(12) Patent Application Publication
(10) Pub. No.: US 2012/0026332 A1
(43) Pub. Date: Feb. 2, 2012

(54) Vision Method and System for Automatically Detecting Objects in Front of a Motor Vehicle

(76) Inventors: Per Jonas Hammarström, Linkoping (SE); Ognjan Hedberg, Linkoping (SE)

(21) Appl. No.: 13/256,501

(22) PCT Filed: Apr. 20, 2010
(86) PCT No.: PCT/EP2010/002391

§ 371 Date: Sep. 14, 2011

(30) Foreign Application Priority Data
Apr. 29, 2009 (EP) 09005920.4

(51) Int. Cl. H04N 7/18

(52) U.S. Cl. 348/148; 348/E07.085

(57) ABSTRACT

A vision method for automatically detecting objects in front of a motor vehicle, comprises the steps of detecting images from a region in front of the vehicle by a vehicle mounted imaging means; generating from said detected images a processed image, containing disparity or vehicle-to-scene distance information; comparing regions-of-interest of said processed image to template objects relating to possible objects in front of the motor vehicle; calculating for each template object a score relating to the match between said processed image and the template object; and identifying large scores of sufficient absolute magnitude of said calculated scores. The vision method further comprises the steps of applying an algorithm adapted to identify groups of said large scores, and assigning an identified group of large scores to a single match object.

### CROSS REFERENCE TO RELATED APPLICATIONS

This application is based on European Patent Application No. 09005920.5, filed Apr. 29, 2009, and PCT International Application No. PCT/EP2010/002391, filed Apr. 20, 2010. The entire content of both applications is hereby incorporated by reference.

### BACKGROUND

1. Field of the Invention

The invention relates to a vision method for automatically detecting objects in front of a motor vehicle, comprising the steps of detecting images from a region in front of the vehicle by a vehicle mounted imaging means, generating a processed image from said detected images containing disparity or vehicle-to-scene distance information, comparing regions-of-interest of said processed image to template objects relating to possible objects in front of the motor vehicle, calculating for each template object a score relating to the match between said processed image and the template object, and identifying large scores of sufficient absolute magnitude of said calculated scores. The invention furthermore relates to a corresponding vision system.

2. Related Technology

Vision methods and systems of this kind are generally known, for example U.S. Pat. No. 7,263,209 B2. In these methods, templates of varying size representing all kinds of objects to be detected are arranged at many different positions in the detected image corresponding to possible positions of an object in the scene. However, processing a large number of template objects increases the overall processing time. Limited processing resources can thus lead to a reduced detection efficiency. Furthermore, although only the peak values of sufficient magnitude of calculated match scores are regarded as a match, multiple detections for one object in the scene cannot be avoided completely. Yet multiple detections for one object can confuse the driver and lead to a reduced acceptance of the system by the driver.

### SUMMARY

An object of the invention is to provide a reliable, efficient and user friendly method and system for automatically detecting objects in front of a motor vehicle.

In overcoming the drawbacks and limitations of the known technology, in one aspect the present invention applies an algorithm adapted to identify groups of large scores and assigns an identified group of large scores to a single match object. This method can avoid multiple detections for the same object in the scene and can prevent driver irritations in response to, for example, a confusing display.

In one preferable aspect, the invention allows the use of only one sort of template objects all having essentially the same size in the imaged scene, which is preferably adapted to the smallest object to be detected. In a further preferred aspect, all template objects have a constant height and/or a constant width in the imaged scene. The use of template objects of only one size significantly reduces the number of template comparisons required, because only one template object has to be positioned at every position on the ground plane in the detected image. Multiple detections which are expected for larger objects are combined to a single match object by a grouping algorithm. The use of template objects all having essentially the same size in the imaged scene leads to a much faster template comparison procedure.

In a further preferable aspect, all template objects have essentially the same height to width ratio, more preferably a height to width ratio larger than one. In another preferable aspect, the template objects have a height and width corresponding to a small pedestrian, like a child, as the smallest object to be detected.

In a further aspect, the grouping algorithm can be applied in a score map to identify large values of the calculated match scores having sufficient magnitude.

In a further preferred aspect, one or more refinement steps may be applied to a detected match object, preferably comprising determining the true height of a detected object. This may be particularly useful if the template objects are arranged to stand on a ground plane in the detected scene and all template objects have the same height, because in this case the real height of a detected object cannot be extracted from the template matching and grouping process. The height determination may be based on a vision refinement algorithm, such as an edge detection algorithm, applied to the detected image data.

Another refinement step may comprise classifying a detected object candidate into one or more of a plurality of object categories, for example pedestrian, other vehicle, large object, bicyclist etc., or general scene objects.

Furthermore, the grouping algorithm may comprise a plurality of grouping rules for different magnitudes of object sizes. Based on which grouping rule corresponds to a particular group, a pre-classification of the object can be made.

### BRIEF DESCRIPTION OF THE DRAWINGS

FIG. 1 shows a schematic view of a vision system for a motor vehicle;

FIG. 2 shows a simplified disparity image with matching template objects; and

FIG. 3 shows a simplified score map for the disparity map shown in FIG. 2.

### DETAILED DESCRIPTION

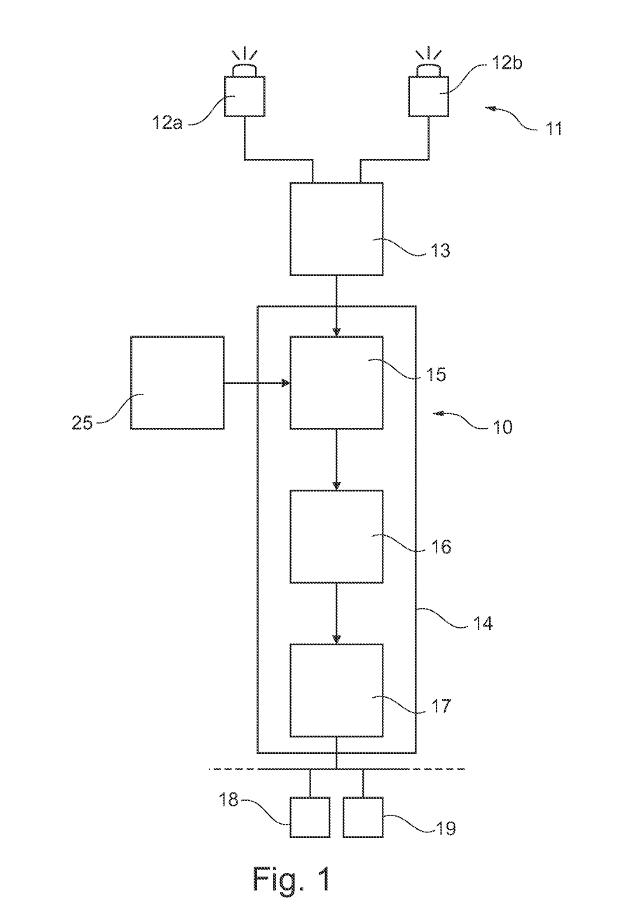

As schematically shown in FIG. 1, vision system 10 is mounted in a motor vehicle and comprises an imaging means 11 for detecting images of a region in front of the motor vehicle. The imaging means 11 may be any arrangement capable of measuring data which allow the generation of depth and/or disparity images, as will be explained below, for example based on stereo vision, LIDAR, a 3D camera, etc. Preferably the imaging means 11 comprises one or more optical and/or infrared cameras 12a, 12b, where infrared covers near IR with wavelengths below 5 microns and/or far IR with wavelengths above 5 microns. Preferably the imaging means 11 comprises two cameras 12a and 12b forming a stereo imaging means 11; alternatively only one camera forming a mono imaging means can be used.

The cameras 12a and 12b are coupled to an image pre-processor 13 adapted to control the capture of images by the cameras 12a and 12b, to receive and digitize the electrical signal from the cameras 12a and 12b, to warp pairs of left/right images into alignment and merge them into single images, and to create multi-resolution disparity images, all of which is known in the art. The image pre-processor 13 may be incorporated in a dedicated hardware circuit. Alternatively the pre-processor 13, or part of its functions, can be incorporated in the electronic processing means 14.

The pre-processed image data is then provided to an electronic processing means 14 where further image and data processing is carried out by corresponding software. In particular, the processing means 14 comprises an object identification means 15 adapted to identify and preferably also classify possible object candidates in front of the motor vehicle, such as pedestrians, other vehicles, bicyclists or large animals. Electronic processing means 14 also preferably comprises a tracking means 16 adapted to track over time the position of object candidates in the detected images identified by the object identification means 15, and a decision means 17 adapted to activate or control vehicle safety means, including for example warning means 18 and display means 19, depending on the result of the processing in the object identification means 15 and tracking means 16. The electronic processing means 14 preferably has access to an electronic memory means 25.

The vehicle safety means may comprise a warning means 18 adapted to provide a collision warning to the driver by suitable optical, acoustical and/or haptical warning signals; display means 19 for displaying information relating to an identified object; one or more restraint systems such as occupant airbags or safety belt tensioners; pedestrian airbags, hood lifters and the like; and/or dynamic vehicle control systems such as brakes.

The electronic processing means 14 is preferably programmed or programmable and may comprise a microprocessor or micro-controller. The image pre-processor 13, the electronic processing means 14 and the memory means 25 are preferably incorporated in an on-board electronic control unit (ECU) and may be connected to the cameras 12a and 12b and the safety means such as warning means 18 and display means 19 via a vehicle data bus. All steps from imaging, image pre- processing, image processing to activation or control of safety means are performed automatically and continuously during driving in real time if the vision system 10 is switched on.

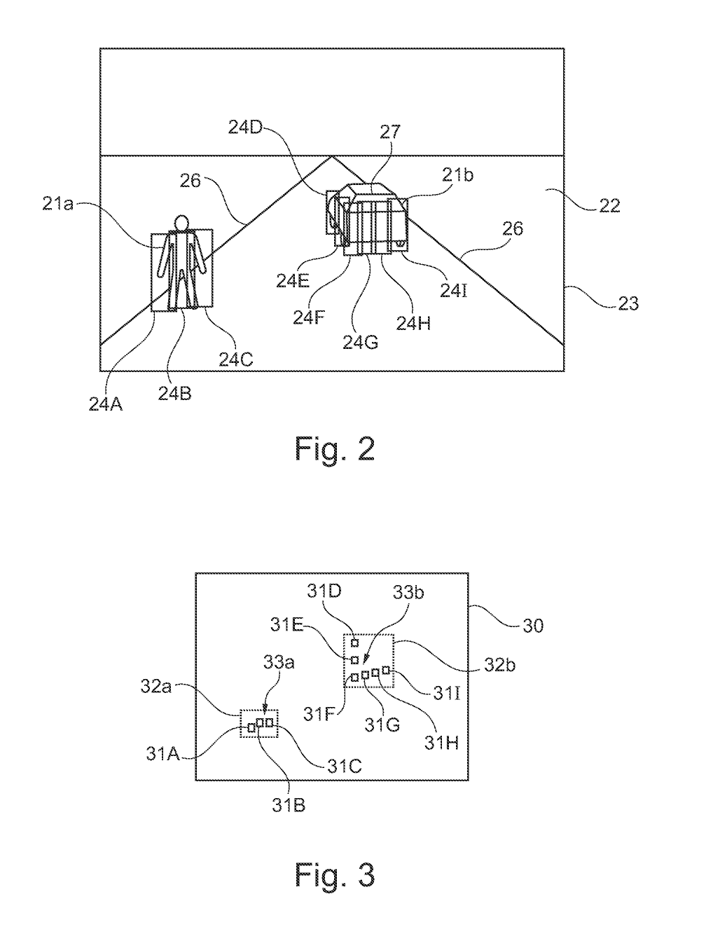

Object identification means 15 preferably generates a disparity image or disparity map 23. An individual disparity value, representing a difference between corresponding points in the scene in the left/right stereo images, is assigned to every pixel of the disparity map. FIG. 2 shows a schematic view of an exemplary disparity map 23 with two objects 21a and 21b to be identified; however, the disparity values in the third dimension are not indicated. In reality the disparity image may for example be a greyscale image where the grey value of every pixel represents a distance between the corresponding point in the scene in the left/right stereo images.

The template objects described below are preferably matched to disparity map 23, thereby advantageously avoiding the time-consuming calculation of a depth map. However, it is also possible to match the pre-stored template objects to a calculated depth map whereby an individual depth value representing the distance between the corresponding point in the scene and the vehicle, obtained from the distance information contained in the disparity image, is assigned to every pixel of the depth map. The term “processed image” means disparity map 23 or a depth image map.

The disparity map 23 (or depth image map) is then compared in the object identification means 15 to template images or template objects such as 24A, 24B, 24C, etc., which may be contained in a template data-base pre-stored in the memory means 25, or generated on-line by means of a corresponding algorithm. As shown in FIG. 2, the template objects 24A, 24B, 24C, etc., represent possible objects in front of the motor vehicle, or parts thereof. All template objects 24A, 24B, 24C, etc., have the same shape, preferably rectangular, and are preferably two-dimensional multi-pixel images which are flat in the third dimension. In other words, only a constant value, for example a constant grey value, indicating the expected disparity or depth of the template object, is assigned to the template image as a whole.

Preferably template objects 24A, 24B, 24C, etc., are arranged to stand on a ground plane 22 of the detected scene in order to reasonably reduce the number of template objects required. In view of this, the electronic processing means 14 is preferably adapted to determine the ground plane 22 from the detected image data, for example by an algorithm adapted to detect the road edges 26. However, it is also possible to determine the ground plane 22 in advance by a measurement procedure. Furthermore, the template objects 24A, 24B, 24C, etc., are preferably arranged orthogonally to a sensing plane which is an essentially horizontal, vehicle-fixed plane through the image sensing cameras 12a and 12b.

All template objects 24A, 24B, and so on through 24I and beyond have a size which corresponds to an essentially fixed size in the detected scene at least in one, and preferably in both dimensions of the template objects 24A, 24B, 24C, etc. This means that preferably the height of the template object times its distance to the vehicle is constant, and preferably the width of the template object times its distance to the vehicle is constant. For example, the height of each template object 24A, 24B, 24C, etc. may correspond to a height of approximately 1 m in the detected scene, and/or the width of each template object 24A, 24B, 24C, etc. may correspond to a width of approximately 0.3 m in the detected scene. The size of the template objects 24A, 24B, 24C, etc. is preferably adapted to the size of the smallest object to be detected, for example a child. Preferably the height of the template objects 24A, 24B, 24C, etc. is less than 1.5 m and the width of the template objects 24A, 24B, 24C, etc. is lower than 0.8 m. More preferably, the height to width ratio of all template objects 24A, 24B, 24C, etc. is constant, in particular larger than one, for example in the range of two to four.

In order to determine objects in the scene in front of the motor vehicle, template objects 24A, 24B, 24C, etc. are arranged at given intervals preferably less than 0.5 m apart, for example approximately 0.25 m apart, along the ground in the scene in the longitudinal and lateral directions in order to cover all possible positions of the object. In FIG. 2 only template objects 24A through 24I are shown, matching with two exemplary objects 21a and 21b. In practice hundreds of template objects 24A, 24B, 24C, etc. may be used.

Every template object 24A, 24B, 24C, etc. is then compared to the disparity map 23 (or to the depth image map) by calculating a difference between the disparity values of the disparity map 23 (or calculating a difference between depth values of the depth image map) and the expected disparity value (or the expected depth value) of the template object, where the calculation is performed over a region-of-interest of the disparity map 23 (or region-of-interest of the depth image map) defined by the template object 24A, 24B, 24C, etc. under inspection. A score indicating the match between the template object 24A, 24B, 24C, etc. under inspection and the corresponding region-of-interest in the disparity map 23 (or in the depth image map) is then calculated, for example as the percentage of pixels for which the absolute magnitude of the above mentioned difference is smaller than a predetermined threshold.

A preferred method of identifying an object based on the above comparison is carried out in the following manner. For every template object 24A, 24B, 24C, etc., the calculated score is saved to a score map 30, an example of which is shown in FIG. 3. In the score map 30, one axis (here the horizontal axis) corresponds to the horizontal axis of the detected image and the other axis (here the vertical axis) is the longitudinal distance axis. Therefore, the score map 30 may be regarded as a birds-eye view on the region in front of the vehicle. All calculated score values are inserted into the score map 30 at the corresponding position in form of a small patch field to which the corresponding score is assigned, for example in form of a grey value.

A step of identifying large score values of sufficient absolute magnitude in the complete score map 30 is then carried out in the object identification means 15, in particular by keeping only those scores which exceed a predetermined threshold and disregarding other score values, for example by setting them to zero in the score map 30. For the exemplary disparity map 23 shown in FIG. 2, the score map 30 after threshold discrimination is shown in FIG. 3, where for each object 21a and 21b to be identified, large score values 31A to 31C and 31D to 31I, respectively, corresponding to matching templates 24A to 24I, remain in the score map 30.

An algorithm adapted to suppress the score values not forming a local extremum (local maximum or local minimum depending on how the score is calculated) may be carried out, leaving left only the locally extremal score values or peak scores. However, this step is not strictly necessary and may in fact be omitted, since the effect of the non-extremum suppression can be achieved by the group identifying step explained below.

In the score map 30, for a single object 21a or 21b to be detected, a plurality of large score values 31A, 31B, 31C or 31D to 31I may result, where a single object for example might also be a group of pedestrians. This is particularly the case if only templates of one relatively small size are used as described above. For example, for the pedestrian 21a three large scores 31A, 31B, 31C may result, and for the vehicle 21b six large scores 31D to 31I may result. In such case the display of a plurality of visual items corresponding to the plurality of matching template objects, or large scores, could be irritating for the driver.

In order to suppress such multiple detections, the object identification means 15 comprises a group identifying means for applying a group identifying algorithm, adapted to identify a group or cluster of matching template objects 24A to 24C or 24D to 24I. That is, for a plurality of matching template objects 24A to 24C or 24D to 24I proximate to each other in a ground plane of the detected scene, the group identifying means assigns an identified cluster of large scores to a single match object 21a or 21b. It is then possible to display only one visual item for each match object such as 21a or 21b which leads to a clear display and avoids irritations of the driver. A matching template object is one with a sufficiently large score value.

It should be noted that the group identifying algorithm, in contrast to non-extremum suppression, is able to identify a group of peak scores, i.e. local extrema in the score map, belonging together.

The group identifying algorithm can preferably be carried out in the score map 30. In this case the group identifying algorithm is adapted to identify a group or cluster such as 33a or 33b of large scores 31A to 31C or 31D to 31I, i.e. a plurality of large scores 31A to 31C or 31D to 31I proximate to each other in a ground plane of the detected scene. For example rectangular areas 32a and 32b can be positioned at regular intervals in the score map 30 and the group identifying algorithm decides whether a cluster of large scores is present or not depending on the number and/or relative arrangement of the large scores 31A, 31B, 31C, etc. included in the area 32a or 32b under inspection.

Other ways of identifying clusters of large scores in the score map 30 may alternatively be applied, and in general other methods of identifying a cluster of matching template objects 24A, 24B, 24C, etc. proximate to each other in a ground plane of the detected scene may alternatively be applied.

Preferably the group identifying algorithm comprises a plurality of group identifying rules corresponding to groups of different size. For example if a group identifying rule corresponding to a relatively small area 32a is applicable, the corresponding object 21a may be pre-classified as a relatively small object like a pedestrian or a pole; if a group identifying rule corresponding to a larger area 32b with dimensions in a specific range is applicable, the corresponding object 21b may be pre-classified as a larger object such as a vehicle or a group of pedestrians, and so on.

A part of the detected image belonging to one group of template objects 24A-24C or template objects 24D-24I may be split up into a plurality of object candidates, which may be sent to a classifying means provided in the electronic processing means 14, in particular a classifier program preferably based on pattern or silhouette recognition means such as neural networks, support vector machines and the like. This allows classification of any identified group into different object categories such as a group of pedestrians, other vehicles, bicyclists, and so on. For example a mini-van sized object could yield four pedestrian candidate regions-of-interest to be sent to a pedestrian classifier, two vehicle candidate regions-of-interest sent to a vehicle classifier, and one mini-van candidate region-of-interest sent to a mini-van classifier.

Since in the embodiment shown in FIG. 2 all template objects 24A, 24B, 24C, etc. have the same height and are arranged on the ground plane of the scene, the true heights of the detected objects 21a and 21b are not known from the template matching and group identifying procedure. Therefore, the object identification means 15 may be adapted to apply a refinement algorithm to the image data in order to determine the true height of the detected objects 21a and 21b. For example a vision refinement algorithm may apply an edge determination algorithm for determining a top edge 27 of a detected object 21b.

1. A vision method for automatically detecting objects in a scene in front of a motor vehicle, comprising the steps of:
detecting images from a region in the front of the vehicle by a vehicle mounted imaging means;
generating from the detected images a processed image containing regions-of-interest and one disparity information and vehicle-to-scene distance information;
comparing the regions-of-interest of the processed image to template objects relating to possible existence of the objects in front of the motor vehicle;
calculating for each of the template objects a score relating to a match between the processed image and the template object;
identifying large scores of sufficient absolute magnitude of the calculated scores;
applying an algorithm adapted to identify groups of the large scores; and
assigning the identified group of large scores to a single match object.

2. The method of claim 1 wherein all template objects have essentially the same size in the imaged scene.

3. The method of claim 1 wherein all the template objects essentially have a size adapted to the smallest object to be detected.

4. The method of claim 1 wherein all the template objects essentially have a constant height in the imaged scene.

5. The method of claim 1 wherein all the template objects essentially have a constant width in the imaged scene.

6. The method of claim 1 wherein all the template objects essentially have the same height to width ratio.

7. The method of claim 1 wherein the template objects have a height to width ratio larger than one.

8. The method of claim 1 wherein the group identifying algorithm is applied in an essentially horizontal score map.

9. The method of claim 1, further comprising the step of determining the height of the detected object.

10. The method of claim 1, further comprising the step of determining an edge in the detected image.

11. The method of claim 1 wherein the group identifying algorithm comprises a plurality of group identifying rules corresponding to groups of different sizes.

12. The method of claim 11 further comprising the step of pre-classifying an identified group of the large scores according to the group size.

13. The method of claim 1 further comprising the step of splitting a part of the detected image belonging to an identified group of the large scores into a plurality of object candidates.

14. The method of claim 13 further comprising the step of classifying an object candidate into one of a plurality of object categories.

15. A vision system for automatically detecting objects in front of a motor vehicle, comprising: a vehicle mounted imaging means for detecting images from a region in front of the vehicle, and
an electronic processing means arranged to carry out the steps of comparing regions-of-interest of a processed image, which processed image is generated from the detected images and which contains one of disparity information and vehicle-to-scene distance information, to template objects relating to the possible existence of the objects in front of the motor vehicle; calculating for each template object a score relating to the match between the processed image and the template object; identifying large scores of sufficient absolute magnitude of the calculated scores; applying an algorithm adapted to identify groups of the large scores; and assigning an identified group of large scores to a single match object.
